(19) United States
(12) Patent Application Publication
(10) Pub. No.: US 2025/0059461 A1
(43) Pub. Date: Feb. 20, 2025

(54) PROCESS FOR REMOVING IMPURITIES FROM VEGETABLE OIL

(71) Applicant: CARGILL, INCORPORATED, Wayzata, MN (US)

(72) Inventor: Falk BRUSE, Drensteinfurt (DE)

(21) Appl. No.: 18/719,331

(22) PCT Filed: Dec. 20, 2022
(86) PCT No.: PCT/US2022/082029

§ 371 Date: Jun. 13, 2024

(30) Foreign Application Priority Data
Dec. 21, 2021 (EP) 21216694.6
Sep. 9, 2022 (EP) 22194745.0

(51) Int. Cl. C11B 3/12

(52) U.S. Cl. CPC C11B 3/12

(57) ABSTRACT

Present invention relates to process for removing impurities from vegetable oil, comprising the step of subjecting vegetable oil to a short-path evaporation, the short-path evaporation being performed at a pressure of below 1 mbar, at an evaporator temperature of more than 200° C. and with a feed rate per unit area of evaporator surface of: (a) more than 400 kg/h·m², whereby the vegetable oil being subjected to the short-path evaporation is a vegetable lauric oil, or (b) more than 170 kg/h·m², whereby the vegetable oil being subjected to the short-path evaporation is palm oil or a palm oil component, or (c) more than 220 kg/h·m², whereby the vegetable oil being subjected to the short-path evaporation is a vegetable liquid oil, and thus obtaining a retentate vegetable oil and distillate. Present invention further relates to the use of short-path evaporation for removing impurities from vegetable oil.

### CROSS-REFERENCE TO RELATED APPLICATIONS

This application claims the benefit of European Patent Application No. 21216694.6, filed Dec. 21, 202, European Patent Application No. 22194745.0, filed Sep. 9, 2022, each of which is incorporated by reference in its entirety.

### FIELD OF THE INVENTION

The present invention relates to a novel process comprising short-path evaporation for obtaining a refined vegetable oil.

### BACKGROUND OF THE INVENTION

Crude oils, as extracted from their original source, are not suitable for human consumption due the presence of impurities—such as free fatty acids, phosphatides, metals and pigments—which may be harmful or may cause an undesirable colour, odour or taste. Crude oils are therefore refined before use. The refining process typically comprises at least one process step that is performed at high temperatures over a longer period of time, such as a deodorizaton step. The oil obtained after completion of the refining process (called a “refined oil” or more specifically a deodorized oil) has a bland odor and taste and is suitable for human consumption. Optionally, when the quality of refined oils has degraded due to bad storage or transportation, oils may be subjected to a subsequent process step that is performed at high temperatures over a longer period of time for restoring their quality.

Existing refining processes, such as deodorization, that are performed at high temperature and low throughput, or short-path evaporation at low specific feed rates, require a high investment.

There is a need in the industry to identify a process allowing a higher production capacity at a reasonable investment cost for efficiently and effectively removing impurities from vegetable oils. The present invention provides such a process.

### SUMMARY OF THE INVENTION

The present invention relates to a process for removing impurities from vegetable oil, wherein the process is comprising the step of subjecting a vegetable oil to a short-path evaporation, wherein the short-path evaporation is performed at a pressure of below 1 mbar, at an evaporator temperature in a range of more than 200° C. and with a feed rate per unit area of evaporator surface of the short-path evaporation equipment of:
more than 400 kg/h·m², whereby the vegetable oil that is subjected to the short-path evaporation is a vegetable lauric oil, or
more than 170 kg/h·m², whereby the vegetable oil that is subjected to the short-path evaporation is palm oil or a palm oil component, or
more than 220 kg/h·m², whereby the vegetable oil that is subjected to the short-path evaporation is a vegetable liquid oil,
   and thus obtaining a retentate vegetable oil and a distillate.

The present invention further relates to use of short-path evaporation for removing impurities from a vegetable oil, wherein the short-path evaporation is performed at a pressure of below 1 mbar, at an evaporator temperature in a range of more than 200° C. and with a feed rate per unit area of evaporator surface of the short-path evaporation equipment of:
more than 400 kg/h·m², whereby the vegetable oil that is subjected to the short-path evaporation is a vegetable lauric oil
more than 170 kg/h·m², whereby the vegetable oil that is subjected to the short-path evaporation is palm oil or a palm oil component
more than 220 kg/h·m², whereby the vegetable oil that is subjected to the short-path evaporation is a vegetable liquid oil,
   and wherein a retentate vegetable oil and a distillate is obtained.

### DETAILED DESCRIPTION

The present invention relates to a process for removing impurities from vegetable oil, wherein the process is comprising the step of subjecting a vegetable oil to a short-path evaporation, wherein the short-path evaporation is performed at a pressure of below 1 mbar, at an evaporator temperature in a range of more than 200° C. and with a feed rate per unit area of evaporator surface of the short-path evaporation equipment of:
more than 400 kg/h·m², whereby the vegetable oil that is subjected to the short-path evaporation is a vegetable lauric oil, or
more than 170 kg/h·m², whereby the vegetable oil that is subjected to the short-path evaporation is palm oil or a palm oil component, or
more than 220 kg/h·m², whereby the vegetable oil that is subjected to the short-path evaporation is a vegetable liquid oil,
   and thus obtaining a retentate vegetable oil and a distillate.

### Vegetable Oil as Starting Material

The vegetable oil that is subjected to the short-path evaporation of the process of the invention may be derived from one or more vegetable sources and may include oils and/or fats from a single origin or blends of two or more oils and/or fats from different sources or with different characteristics.

Examples of suitable vegetable oils include algal oil, camelina oil, coconut oil, corn oil, cottonseed oil, cottonseed oil fractions, grape seed oil, hazelnut oil, jojoba oil, kapok seed oil, linseed oil, olive oil, palm oil, palm oil components, palm kernel oil, palm kernel stearin, palm kernel olein, peanut oil, pecan oil, perilla oil, pistachio oil, poppy seed oil, rapeseed oil, rice bran oil, safflower oil, sesame oil, sunflower oil, high- and mid-oleic sunflower oil, soy bean oil, walnut oil, wheat germ oil, babassu oil, cohune oil, tacum oil, cuphea oil and any combination of two or more thereof.

More preferably, the vegetable oil that is subjected to the short-path evaporation of the process of the invention is selected from the list consisting of camelina oil, coconut oil, corn oil, cottonseed oil, cottonseed oil fractions, linseed oil, palm oil, palm oil components, palm kernel oil, palm kernel stearin, palm kernel olein, rapeseed oil, sunflower oil, high- and mid-oleic sunflower oil, soybean oil, and any combination of two or more thereof.

Most preferably, the vegetable oil that is subjected to the short-path evaporation of the process of the invention is selected from the list consisting of coconut oil, corn oil, cottonseed oil, cottonseed oil fractions, palm oil, palm stearin, palm olein, palm mid fractions, palm kernel oil, palm kernel stearin, palm kernel olein, rapeseed oil, sunflower oil, high- and mid-oleic sunflower oil, soybean oil, and any combination of two or more thereof.

The term “Palm oil component” is encompassing stearin and olein fractions (single as well as double fractionated, and palm mid fractions), hydrogenated palm oil or hydrogenated palm oil fractions, interesterified palm oil or interesterified palm oil fractions, blends of 2 or more thereof, and blends thereof with palm oil.

The term “vegetable lauric oil” is encompassing vegetable oils having a content of C6 to C12 fatty acids of more than 50%. Examples of such an oil include coconut oil, palm kernel oil, babassu oil, cohune oil, tacum oil and cuphea oil or any mixture of two or more thereof. For the purposes of the present invention, the vegetable lauric oil will preferably be coconut oil and/or palm kernel oil, most preferably coconut oil.

The term “vegetable liquid oil” is encompassing vegetable oils having melting point of 20° C. or less. Examples of vegetable oils having a melting point of 20° C. or less are linseed oil, olive oil, rapeseed oil, safflower oil, sesame oil, sunflower oil, high- and mid-oleic sunflower oil, soybean oil.

In one aspect of the invention, the vegetable oil that is subjected to the short-path evaporation of the process is a degummed, bleached and/or deodorized vegetable oil. Preferably the vegetable oil is at least degummed.

Crude vegetable oil may be subjected to one or more degumming steps. Any of a variety of degumming processes known in the art may be used. One such process (known as “water degumming”) includes mixing water with the oil and separating the resulting mixture into an oil component and an oil-insoluble hydrated phosphatides component, sometimes referred to as “wet gum” or “wet lecithin”. Alternatively, phosphatide content can be reduced (or further reduced) by other degumming processes, such as acid degumming (using citric or phosphoric acid for instance), enzymatic degumming (e.g., ENZYMAX from Lurgi) or chemical degumming (e.g., SUPERIUNI degumming from Unilever or TOP degumming from VandeMoortele/Dijkstra CS). Alternatively, phosphatide content can also be reduced (or further reduced) by means of acid conditioning, wherein the oil is treated with acid in a high shear mixer and is subsequently sent without any separation of the phosphatides to the bleaching step.

The bleaching step in general is a process step whereby impurities are removed to improve the color and flavor of the oil. It is typically performed prior to deodorization. The nature of the bleaching step will depend, at least in part, on the nature and quality of the oil being bleached. Generally, a crude or partially refined oil will be mixed with a bleaching agent which combines, amongst others, with oxidation products, phosphatides, trace soaps, pigments and other compounds to enable their removal. The nature of the bleaching agent can be selected to match the nature of the crude or partially refined oil to yield a desirable bleached oil. Bleaching agents generally include natural or “activated” bleaching clays, also referred to as “bleaching earths”, activated carbon and various silicates. Natural bleaching agent refers to non-activated bleaching agents. They occur in nature or they occur in nature and have been cleaned, dried, milled and/or packed ready for use. Activated bleaching agent refers to bleaching agents that have been chemically modified, for example by activation with acid or alkali, and/or bleaching agents that have been physically activated, for example by thermal treatment. Activation includes the increase of the surface in order to improve the bleaching efficiency.

Further, bleaching clays may be characterized based on their pH value. Typically, acid-activated clays have a pH value of 2.0 to 5.0. Neutral clays have a pH value of 5.5 to 9.0.

A skilled person will be able to select a suitable bleaching agent from those that are commercially available based on the oil being refined and the desired end use of that oil

The bleaching step for obtaining the degummed and bleached vegetable oil that is subjected to the short-path evaporation of the process, is performed at a temperature of from 80 to 115° C., from 85 to 110° C., or from 90 to 105° C., in presence of bleaching earth in an amount of from 0.2 to 5%, from 0.5 to 3%, or from 0.7 to 1.5% based on amount of oil.

Deodorization is a process whereby free fatty acids (FFAs) and other volatile impurities are removed by treating (or “stripping”) a crude or partially refined oil under vacuum and at elevated temperature with sparge steam, nitrogen or other gasses. The deodorization process and its many variations and manipulations are well known in the art and the deodorization step of the present invention may be based on a single variation or on multiple variations thereof.

For instance, deodorizers may be selected from any of a wide variety of commercially available systems (such as those sold by Krupp of Hamburg, Germany: De Smet Group, S.A. of Brussels, Belgium: Gianazza Technology s.r.l. of Legnano, Italy: Alfa Laval AB of Lund, Sweden Crown Ironworks of the United States, or others). The deodorizer may have several configurations, such as horizontal vessels or vertical tray-type deodorizers.

Deodorization is typically carried out at elevated temperatures and reduced pressure to better volatilize the FFAs and other impurities. The precise temperature and pressure may vary depending on the nature and quality of the oil being processed. The pressure, for instance, will preferably be no greater than 10 mm Hg but certain aspects of the invention may benefit from a pressure below or equal to 5 mm Hg, e.g. 1-4 mm Hg. The temperature in the deodorizer may be varied as desired to optimize the yield and quality of the deodorized oil. At higher temperatures, reactions which may degrade the quality of the oil will proceed more quickly. For example, at higher temperatures, cis-fatty acids may be converted into their less desirable trans form. Operating the deodorizer at lower temperatures may minimize the cis-to-trans conversion, but will generally take longer or require more stripping medium or lower pressure to remove the requisite percentage of volatile impurities. As such, deodorization is typically performed at a temperature of the oil in a range of 200 to 280° C., with temperatures of about 220-270° C. being useful for many oils. Typically, deodorization is thus occurring in a deodorizer whereby volatile components such as FFAs and other unwanted volatile components that may cause off-flavors in the oil, are removed. Deodorization may also result in the thermal degradation of unwanted components.

The deodorization step for obtaining the degummed, bleached and deodorized vegetable oil that is subjected to the short-path evaporation of the process, is performed at a temperature of from 200° C. to 270° C., from 210° C. to 260° C., or from 220° C. to 250° C. The deodorization step is taking place for a period of time from 30 min to 240 min, from 45 min to 180 min, or from 60 min to 150 min.

The deodorization step for obtaining the degummed, bleached and deodorized vegetable oil that is subjected to the short-path evaporation of the process, is performed in the presence of sparge steam in a range of from 0.50 to 2.50 wt %, from 0.75 to 2.00 wt %, from 1.00 to 1.75 wt %, or from 1.25 to 1.50 wt % based on amount of oil, and at an absolute pressure of 10 mbar or less, 7 mbar or less, 5 mbar or less, 3 mbar or less, 2 mbar or less.

Typically, a degummed, bleached and deodorized vegetable edible oil is known to be obtained by means of 2 major types of refining processes, i.e. a chemical or a physical refining process. The chemical refining process may typically comprise the major steps of degumming, alkali refining, also called neutralization, bleaching and deodorizing. The thus obtained deodorized oil is a chemically refined oil, also called “NBD” oil. Alternatively, the physical refining process may typically comprise the major steps of degumming, bleaching and deodorizing. A physically refining process is not comprising an alkali neutralization step as is present in the chemical refining process. The thus obtained deodorized oil is a physically refined oil, also called “RBD” oil.

The vegetable oil that is subjected to the short-path evaporation of the process is a degummed, bleached and deodorized vegetable oil and a method for obtaining the degummed, bleached and deodorized vegetable oil is comprising the steps of:
i) Degumming and obtaining a degummed vegetable oil,
ii) Optionally alkali neutralizing the degummed vegetable oil from step i),
iii) Bleaching the degummed oil from step i) or the alkali neutralized oil from step ii)
   at a temperature of from 80 to 115° C., from 85 to 110° C., or from 90 to 105° C.,
   with neutral and/or natural bleaching earth in an amount of from 0.2 to 5%, from 0.5 to 3%, or from 0.7 to 1.5%, and obtaining a degummed and bleached oil, and
iv) Deodorizing the degummed, optionally alkali neutralized, and bleached oil from step iii)
   at a temperature of from 200 to 270° C., from 210 to 260° C., or from 220 to 250° C.,
   for a period of time in a range of from 30 min to 240 min, from 45 min to 180 min, or from 60 min to 150 min.

The vegetable oil that is subjected to the short-path evaporation may have an elevated content of impurities such as, but not limited to aldehydes, ketones, peroxides, solvents, alkanes having a carbon chain length up to C10, MOSH (Mineral Oil Saturated Hydrocarbons) having a carbon chain length between C10 and C35, MOAH (Mineral Oil Aromatic Hydrocarbons) having a carbon chain length between C10 and C35, FFA, GE (Glycidyl Esters).

The vegetable oil that is subjected to the short-path evaporation may have a content of MOSH of 20 ppm or higher, 40 ppm or higher, 60 ppm or higher, or even 80 ppm or higher. The content of MOAH may be more than 5 ppm or higher, more than 10 or higher, more than 20 ppm or higher, more than 40 ppm or higher, or even more than 60 ppm or higher

Method DIN EN 16995:2017 (as part of CEN/TC275/WG 13) is the method that is used to measure the content of MOSH as well as the content of MOAH. The “content of MOSH” is defined as the total amount of saturated hydrocarbons (MOSH) with a carbon chain length in a range of C10 to C50. The “content of MOAH” is defined as the total amount of aromatic hydrocarbons (MOAH) with a carbon chain length in a range of C10 to C50.

The vegetable oil that is subjected to the short-path evaporation may be an RBD oil or an NBD oil. Preferably, the vegetable oil that is subjected to the short-path evaporation is an RBD oil. Furthermore, the vegetable oil that is subjected to the short-path evaporation may be an RBD or NBD oil having an FFA content in a range of more than 0.05%, 0.08% or more than 0.1% and/or a peroxide value of more than 0.5 meq peroxide/kg, more than 0.8 meq peroxide/kg, or more than 1.0 meq peroxide/kg. These RBD or NBD oils may have an elevated level of FFA and/or peroxide value due to bad refining conditions or due to aging of the oil as a result of long and/or bad conditions of storage and/or transportation. Apart from an elevated level of FFA and/or peroxide value, these oils typically also have an off taste, such as but not limited to rancid taste or cardboard taste, and/or a darker colour.

FFA is measured according to official AOCS method Ca 5a-40. The percentage of FFA (expressed as weight percentage on total weight of oil) oils is calculated as oleic acid, except for lauric oils such as coconut oil and palm kernel oil, wherein the FFA % is expressed as lauric acid, and for palm oil and palm oil components wherein the % FFA is expressed as palmitic acid

Peroxide value, in meq peroxide/kg, is measured according to official AOCS method Cd 8b-90. It is a method well-known in the art for measuring peroxides or similar products of fat oxidation that may be present in the oil

The content of GE is measured with Method DGF Standard Methods Section C (Fats) C-VI 18(10).

### Short-Path Evaporation

Short-path evaporation, also called short-path distillation or molecular distillation, is a distillation technique that involves the distillate travelling a short distance, often only a few centimetres, and it is normally done at reduced pressure. With short path distillation, a decrease of boiling temperature is obtained by reducing the operating pressure. It is a continuous process with very short residence time. This technique is often used for compounds which are unstable at high temperatures or to purify small amounts of compounds. The advantage is that the heating temperature can be considerably lower (at reduced pressure) than the boiling point of the liquid at standard pressure. Additionally, short-path evaporation allows working at very low pressure.

Different types of short-path evaporation apparatus can be used that are well known to the skilled person. Examples are, but are not limited to, falling film, centrifugal, or wiped film evaporation apparatus. Preferably the short-path evaporation of the current process is performed in a wiped film evaporation apparatus.

The short-path evaporation is performed at a pressure below 1 mbar, preferably below 0.05 mbar, more preferably below 0.01 mbar, most preferably below 0.001 mbar.

The short-path evaporation is further performed at specific conditions of temperature and feed rate per unit area of evaporator surface of the short-path evaporation equipment.

The “feed rate per unit area of evaporator surface of the short-path evaporation equipment”, also called “specific throughput” or “specific feed rate”, expressed in kg/h·m², is defined as the flow of oil, expressed in kg/h, per unit area of evaporator surface of the short-path evaporation equipment, expressed in square meters (m²). The feed rate per unit area of evaporator surface of the short-path evaporation equipment in the process of the current invention is applicable to any short path equipment, including industrial short-path evaporation equipment independent of the dimensions of the equipment. Preferably stainless steel short-path evaporation equipment is used in the current invention.

The short-path evaporation of the current process is performed at an evaporator temperature in a range of from more than 200 to 350° C., from 210 to 310° C., or from 220 to 280° C.

In one aspect of the invention, the short-path evaporation of the current invention is performed at a temperature in a range of from more than 200 to 270° C., from 205 to 260° C., or from 210 to 250° C., and at a specific throughput in a range of from 400 to 1000 kg/h·m², from 410 to 900 kg/h·m² or from 420 to 800 kg/h·m², and whereby the vegetable oil that is subjected to the short-path evaporation is a vegetable lauric oil.

In another aspect of the invention, the short-path evaporation of the current invention is performed at a temperature in a range of from more than 200 to 350° C., from 210 to 290° C., or from 220 to 280° C., and at a specific throughput in a range of from more than 170 to 1000 kg/h·m², from 200 to 900 kg/h·m² or from 240 to 800 kg/h·m², and whereby the vegetable oil that is subjected to the short-path evaporation is palm oil or a palm oil component.

In one more aspect of the invention, the short-path evaporation of the current invention is performed at a temperature in a range of from more than 200 to 350° C., from 210 to 290° C., or from 220 to 280° C., and at a specific throughput in a range of from more than 220 to 1000 kg/h·m², from 240 to 900 kg/h·m² or from 260 to 800 kg/h·m², and whereby the vegetable oil that is subjected to the short-path evaporation is a vegetable liquid oil.

In the process according to the invention, two fractions are obtained from the short-path evaporation: a retentate vegetable oil and a distillate.

The process according to the invention results in a retentate vegetable oil having a reduced content of impurities and a distillate having an elevated content of impurities, compared to the vegetable oil that is subjected to the short-path evaporation.

Surprisingly, it has been found that the process according to the invention, performing a short-path evaporation step with a very high feed rate per unit area of evaporator surface of the short-path evaporation equipment of more than 400 kg/h·m² for vegetable lauric oils, more than 170 kg/h·m² for palm oil or palm oil components or more than 220 kg/h·m² for vegetable liquid oils results in a retentate vegetable oil having a reduction of impurities, a reduced peroxide value, a better taste and/or a better maintenance of its original colour. Such short-path evaporation processes conducted with a very high feed rate per unit area of evaporator surface of the short-path evaporation equipment may require a significantly smaller dimension of the evaporator unit than the dimension of commonly used refining equipment that is required for treating the same volume of oil. As a result, the process according to the invention will require less investment cost

The process according to the invention results in a yield of the retentate vegetable oil that is more than 90%, or more than 95%, or more than 99%. The yield is expressed as the ratio of the amount of retentate vegetable liquid oil that is obtained versus the amount of vegetable liquid oil that was subjected to the short-path evaporation.

The process according to the invention, which is performing a short-path evaporation step at low temperatures may result in a retentate vegetable oil having a reduction of FFA content, the GE content and/or the peroxide value by at least 50%, at least 60%, at least 70%. Furthermore, the process according to the invention may result in a retentate vegetable oil having a reduction of MOSH and/or MOAH by at least 20%, at least 30%, at least 40%.

The process according to the invention may result in a retentate vegetable oil having an overall flavour quality score (taste), according to AOCS method Cg 2-83, in a range of from 7 to 10, or from 8 to 10 or from 9 to 10 (with 10 being an excellent overall flavour quality score and 1 being the worst score).

### The Use of a Short-Path Evaporation

The present invention further relates to the use of short-path evaporation for removing impurities from a vegetable oil, wherein the short-path evaporation is performed at a pressure of below 1 mbar, at an evaporator temperature in a range of more than 200° C. and with a feed rate per unit area of evaporator surface of the short-path evaporation equipment of:
more than 400 kg/h·m², whereby the vegetable oil that is subjected to the short-path evaporation is a vegetable lauric oil
more than 170 kg/h·m², whereby the vegetable oil that is subjected to the short-path evaporation is palm oil or a palm oil component
more than 220 kg/h·m², whereby the vegetable oil that is subjected to the short-path evaporation is a vegetable liquid oil,
   and wherein a retentate vegetable oil and a distillate is obtained.

The present invention further relates to the use wherein the vegetable oil is a degummed, bleached and deodorized vegetable oil.

The use of the current process relates to a short-path evaporation being performed at an evaporator temperature in a range of from more than 200 to 350° C., from 210 to 310° C., or from 220 to 280° C.

In one aspect, the current invention relates to the use short-path evaporation of the current invention is performed at a temperature in a range of from more than 200 to 270° C., from 205 to 260° C., or from 210 to 250° C., and at a specific throughput in a range of from 400 to 1000 kg/h·m², from 410 to 900 kg/h·m² or from 420 to 800 kg/h·m², and whereby the vegetable oil that is subjected to the short-path evaporation is a vegetable lauric oil.

In another aspect, the current invention relates to the use of short-path evaporation of the current invention is performed at a temperature in a range of from more than 200 to 350° C., from 210 to 290° C., or from 220 to 280° C., and at a specific throughput in a range of from more than 170 to 1000 kg/h·m², from 200 to 900 kg/h·m² or from 240 to 800 kg/h·m², and whereby the vegetable oil that is subjected to the short-path evaporation is palm oil or a palm oil component.

In one more aspect, the current invention relates to the use of short-path evaporation of the current invention is performed at a temperature in a range of from more than 200 to 350° C., from 210 to 290° C., or from 220 to 280° C., and at a specific throughput in a range of from more than 220 to 1000 kg/h·m², from 240 to 900 kg/h·m² or from 260 to 800 kg/h·m², and whereby the vegetable oil that is subjected to the short-path evaporation is a vegetable liquid oil.

### Examples

### 1. Starting Material

Refined, bleached and deodorized (RBD) oils are spiked with deodorizer distillate obtained from the deodorization of the corresponding oil to simulate RBD oils having an increased FFA content due to transportation or long storage under bad conditions. The oils are spiked with deodorizer distillate to obtain an FFA content of about 0.3 wt. %, expressed on total weight of the oil. An overview of starting materials is given in Table 1.

TABLE 1
Overview of the starting materials:

| | Type of | Type of deodorizer | Targetted content of |
|---|---|---|---|
| | RBD oil | distillate | FFA in sample |
| Sample A | Coconut oil | Coconut deodorized | 0.3 wt. % |
| | | distillate | |
| Sample B | Palm oil | Palm oil deodorizer | 0.3 wt. % |
| | | distillate | |
| Sample C | Rapeseed oil | Rapeseed deodorizer | 0.3 wt. % |
| | | distillate | |

### 2. SPE Conditions

Short-Path Evaporation (SPE) Unit KD10 from UIC was used for the short-path evaporation. The KD10 unit has an evaporator surface of 0.1 m²

The following conditions were applied:
Feed-temperature: 144° C.
Condenser Temp.: 140° C.
Wiper speed: 400 rpm
Pressure: below 10-3 mbar
Test conditions: Feed rate per unit area of evaporator surface of the short-path evaporation equipment (in kg/h·m²) and evaporation temperature that is applied for each sample, is set as given in table 2.

TABLE 2
SPE conditions per sample

| | | | Feed rate per unit area |
|---|---|---|---|
| | Starting | Evaporation | of evaporator surface |
| | materials | temperature | of in KD10 (kg/h · m²) |
| Test 1 | Sample A | 250° C. | 450 |
| Test 2 | Sample B | 250° C. | 300 |
| Test 3 | Sample C | 250° C. | 350 |
| Test 4 | Sample A | 270° C. | 750 |
| Test 5 | Sample B | 270° C. | 750 |
| Test 6 | Sample C | 270° C. | 750 |

Thus, the example is conducted according to the specifications of the claims.

### 3. Results

For each test FFA is measured as well as the color before the SPE treatment (=starting material of test) and after (=retentate of test). The yield of the retentate vegetable oil is calculated for each test based on the amount of retentate vegetable oil after SPE treatment versus the amount of spiked RBD oil before the SPE treatment.

1. A process for removing impurities from vegetable oil, wherein the process is comprising the step of subjecting a vegetable oil to a short-path evaporation, wherein the short-path evaporation is performed at a pressure of below 1 mbar, at an evaporator temperature in a range of more than 200° C. and with a feed rate per unit area of evaporator surface of the short-path evaporation equipment of:
more than 400 kg/h·m², whereby the vegetable oil that is subjected to the short-path evaporation is a vegetable lauric oil, or
more than 170 kg/h·m², whereby the vegetable oil that is subjected to the short-path evaporation is palm oil or a palm oil component, or
more than 220 kg/h·m², whereby the vegetable oil that is subjected to the short-path evaporation is a vegetable liquid oil,
and thus obtaining a retentate vegetable oil and a distillate.

2. The process according to claim 1, wherein the vegetable oil is a degummed, bleached and deodorized vegetable oil.

3. The process according to claim 1 wherein the short-path evaporation is performed at a pressure below 0.01 mbar.

4. The process according to claim 1, wherein the short-path evaporation of the current invention is performed at a temperature in a range of from more than 200 to 270° C. and at a specific throughput in a range of from 400 to 1000 kg/h·m², and whereby the vegetable oil that is subjected to the short-path evaporation is a vegetable lauric oil.

5. The process according to claim 1, wherein the short-path evaporation is performed at a temperature in a range of from more than 200 to 350° C. and at a specific throughput in a range of from more than 170 to 1000 kg/h·m², and whereby the vegetable oil that is subjected to the short-path evaporation is palm oil or a palm oil component.

6. The process according to claim 1, wherein the short-path evaporation of the current invention is performed at a temperature in a range of from more than 200 to 350° C. and at a specific throughput in a range of from more than 220 to 1000 kg/h·m², and whereby the vegetable oil that is subjected to the short-path evaporation is a vegetable liquid oil.

7-8. (canceled)
